(19) United States
(12) Patent Application Publication
(10) Pub. No.: US 2007/0135164 A1
(43) Pub. Date: Jun. 14, 2007

(54) Mobile communication terminal having ic card settlement function

(75) Inventor: Min-Hwa Lee, Seoul (KR)

Correspondence Address: SEYFARTH SHAW, LLP, 815 CONNECTICUT AVENUE, N.W., SUITE 500, WASHINGTON, DC, 20006, US

(73) Assignee: HEALTHPIA CO., LTD., Kangwon-do (KR)

(21) Appl. No.: 10/538,021

(22) PCT Filed: Oct. 10, 2003
(86) PCT No.: PCT/KR03/02092

§ 371 Date: Nov. 30, 2006

(30) Foreign Application Priority Data
Dec. 7, 2002 (KR) 10-2002-0077608

(51) Int. Cl. H04M 1/00; H04B 1/38

(52) U.S. Cl. 455/558

(57) ABSTRACT

The present invention relates to a method which supplies hard-ware to a mobile communication terminal. And it also discloses a payment method for a commercial transaction. A mobile communication terminal of the present invention includes a contactless IC chip module for handling payment in the machine itself The invention process reading/writing directly by interfacing its chip module with a serial interface to a micro-processor of the terminal. Therefore, it is possible to renew card information, and to issue/cancel a card, and to save multiple cards. By selecting a function, a mobile communication terminal uses it as on-line payment or contactless off-line payment.

### TECHNICAL FIELD

The present invention relates to additional functions of a mobile communication terminal, and more particularly to technology to add hardware to a mobile communication terminal so as to use it as means for performing business transaction.

### BACKGROUND ART

As a technology to utilize a mobile communication terminal as a payment means, there was a trial to incorporate an IC chip into a flip of a flip-type mobile communication terminal so as to use it as a bus card. This idea is advantageous in that it overcomes the inconvenience of carrying cards, but has many limitations in terms of the card issuance process.

Another prior art approach can be seen in Korean Patent Publication No. 2002-23098, published on Mar. 28, 2002. In this prior art, a card having a bar code form is transmitted to and stored in a mobile communication terminal, and a scanner in a settlement terminal reads the card data to perform settlement inquiry and approval processes in a similar manner to a standard credit-card settlement terminal. This technology has suggested a software card so that the card can be updated and a plurality of cards can be stored in the mobile communication terminal. Although it seems to be an excellent idea, this technology is disadvantageous in that it has very weak security characteristics.

### DISCLOSURE OF THE INVENTION

Therefore, the present invention has been made in view of the above problems, and it is an object of the present invention to provide a payment means that has a high security level and allows data to be updated, and can also be issued and transmitted online through a communication network.

It is another object of the present invention to provide a payment means integrated into a mobile communication terminal that can perform a settlement process in a settlement terminal in the same manner as conventional contact-free credit cards.

It is yet another object of the present invention to provide a mobile communication terminal that has a high security level while supporting a plurality of payment means.

In accordance with one aspect of the present invention, the above and other objects can be accomplished by the provision of a mobile communication terminal for providing a settlement means, said terminal comprising an IC chip module for performing settlement information and a main body circuit unit, said IC chip module being embedded in the mobile communication terminal, said IC chip module including: a memory for storing a card operating system and card information; a chip interface for performing data transmission/reception with the outside; and a chip controller being controlled by the card operating system to update card information and perform a transaction process through the chip interface, said main body circuit unit including: a key pad; a display unit; a communication module; and a controller for receiving card information through the communication module, and requesting, via an external interface, to update the card information in the IC chip module.

The settlement means according to this aspect of the present invention can be transmitted through a communication network, and it also has a high security level while the content thereof can be modified.

In accordance with another aspect of the present invention, there is provided a mobile communication terminal for providing a settlement means, said terminal comprising an IC chip module for performing settlement information and a main body circuit unit, said IC chip module being embedded in the mobile communication terminal, said IC chip module including: a memory for storing a card operating system and card information; a chip interface for performing data transmission/reception with the outside; and a chip controller being controlled by the card operating system, said controller including a communication transaction processor for accessing the card information in the memory upon receipt of transaction request information through the chip interface and outputting it through the chip interface, said main body circuit unit including: a key pad; a display unit; a communication module; and a controller including a transaction processor for requesting, via the external interface, to perform a transaction process in response to manipulation of the key pad when a transaction process is performed through the communication module, and receiving response data to perform the transaction process through the communication module.

The settlement means according to this aspect of the present invention is a chip-type settlement means, which has a high security level and also makes it possible to perform simple settlement of a transaction through a communication network.

Preferably, the IC chip module further includes an RF communication module for communicating wirelessly with an external transaction terminal, and the transaction processor in the chip controller includes a contact-free transaction processor for receiving contact-free transaction request information from the outside through the RF communication module, reading card information in the memory, and outputting the read card information through the RF communication module, so as to perform a settlement process thereof.

Accordingly, it is possible for the mobile communication terminal to support settlement through a communication network and contact-free settlement at the same time.

Preferably, in the IC chip module, the memory stores a plurality of cards' information; the card update unit individually accesses the plurality of cards' information in the memory and updates each card's information; and the transaction processor performs the transaction process by selecting card information of a card selected through the chip interface from a plurality of cards.

Accordingly, it is possible for a single mobile communication terminal to support a plurality of settlement means.

Preferably, the communication module in the main body circuit unit includes a first communication unit for supporting voice and data communication with a base station; and a second communication unit for supporting local wireless communication with an access point, wherein the transaction processor selectively accesses the first or second communication units.

Accordingly, the mobile communication terminal supports not only settlement through a mobile communication network employing a base station, but also settlement through a local area communication network such as Bluetooth and wireless LAN.

### BRIEF DESCRIPTION OF THE DRAWINGS

The above and other objects, features and other advantages of the present invention will be more clearly understood from the following detailed description taken in conjunction with the accompanying drawings, in which:

FIG. 1 schematically shows the configuration of a mobile communication terminal according to an embodiment of the present invention;

FIG. 2 is a block diagram schematically showing the overall configuration of a mobile communication terminal according to the embodiment of the present invention;

FIG. 3a is a flow diagram showing the procedure of issuing a card, according to the preferred embodiment of the present invention; and

FIG. 3b shows the procedure for performing online settlement according to the embodiment of the present invention.

### BEST MODE FOR CARRYING OUT THE INVENTION

The above and other aspects of the present invention will be described through preferred embodiments with reference to the accompanying drawings. The following description will be given in detail so as to allow those skilled in the art to easily understand and realize the present invention through the preferred embodiments.

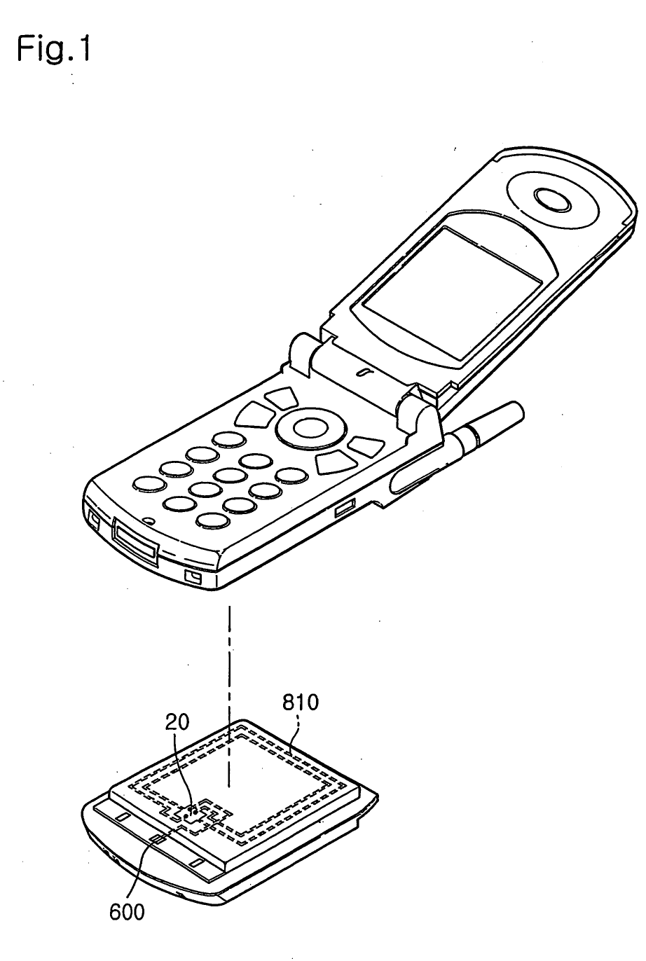

FIG. 1 schematically shows the configuration of a mobile communication terminal according to an embodiment of the present invention. In a preferred embodiment, an IC chip 20 embedded in a battery pack of the mobile communication terminal performs a payment process. The IC chip 20 is connected to an RF antenna 810 so that it can perform a contact-free payment process. The IC chip 20 is also connected to a terminal 600 as a serial communication interface typically included in IC chips, which allows the serial communication interface (for example, an RS-232 interface) in the IC chip 20 to be connected to a serial communication interface in the mobile communication terminal. When the battery pack is attached to a main body of the mobile communication terminal, the terminal 600 in the battery pack is connected to a terminal formed on a corresponding surface of the main body of the mobile terminal, while the two terminals are elastically supported by each other. This connection allows serial communication between the battery pack and the main body of the mobile communication terminal. In the case of a half-duplex scheme, bi-directional serial communication is possible through two lines, so that the terminal 600 practically includes a plurality of electrical connection points. However, the present invention is not limited to the embodiment shown in FIG. 1. For example, the IC chip 20 and the antenna 810 may also be embedded in the bottom surface of the main body of the mobile communication terminal, or in the front surface of a cover of a folder type mobile communication terminal. When adapted for embodiments not supporting a contact-free payment, the IC chip 20 and antenna 810 are formed to occupy a small area of the mobile communication terminal so that they can be installed in any portion of the mobile communication terminal.

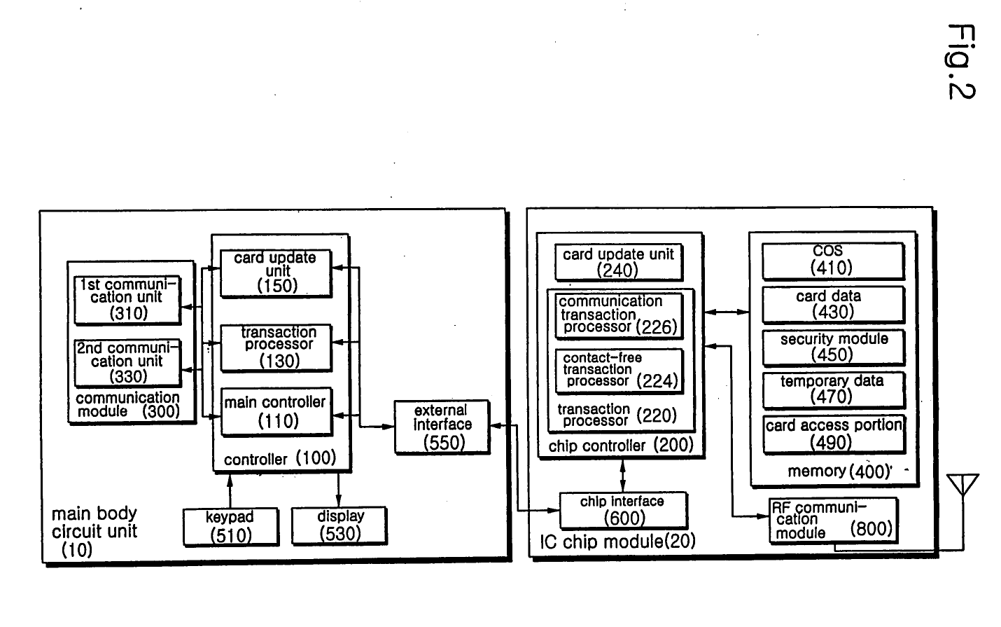

FIG. 2 is a block diagram schematically showing the overall configuration of a mobile communication terminal according to a preferred embodiment of the present invention.

In the preferred embodiment, the mobile communication terminal includes therein an IC chip module 20 in addition to a main body circuit unit 10. The IC chip module 20 is embedded in a battery pack in the embodiment, but the present invention is not limited thereto.

The main body circuit unit 10 includes general mobile communication terminal circuitry. In detail, as shown in FIG. 2, the circuit unit 10 includes a controller 100, a communication module 300 and an external interface 550. The circuit unit 10 further includes a display unit 530 and a keypad 510 as an operating unit used in a general mobile communication terminal. The controller 100 is construed to include a microprocessor embedded in a main chip of a mobile communication terminal, and a program code for controlling the microprocessor.

The communication module 300 includes a first communication unit 310. The first communication unit 310 performs general mobile communication, which supports voice and data communication through a base station. According to an advantageous aspect of the present invention, the communication module 300 may further include a second communication unit 330 that supports local wireless communication. The most recent mobile communication terminals include therein a Bluetooth wireless communication module. This module becomes available by additionally installing a corresponding application program on the mobile communication terminal. Another mobile communication terminal supports infrared wireless communication. According to an advantageous aspect of the present invention, the mobile communication terminal performs a payment process by communicating with a settlement terminal through such local area wireless communication.

Currently used mobile communication terminals provide a serial communication link such as RS-232 or USB communication links. The external interface 550 may be such a serial communication link. It is known in the art that a serial communication interface (i.e., the chip interface 600) inherently supported by the IC chip module 20 is an RS-232 interface. The external interface 550 is extended or branched out from the main body circuit unit 10 by an electrical wire to maintain an electrical connection with the chip interface 600. Alternatively, the external interface 550 may be detachably coupled to the main body circuit unit 10 as shown in FIG. 1.

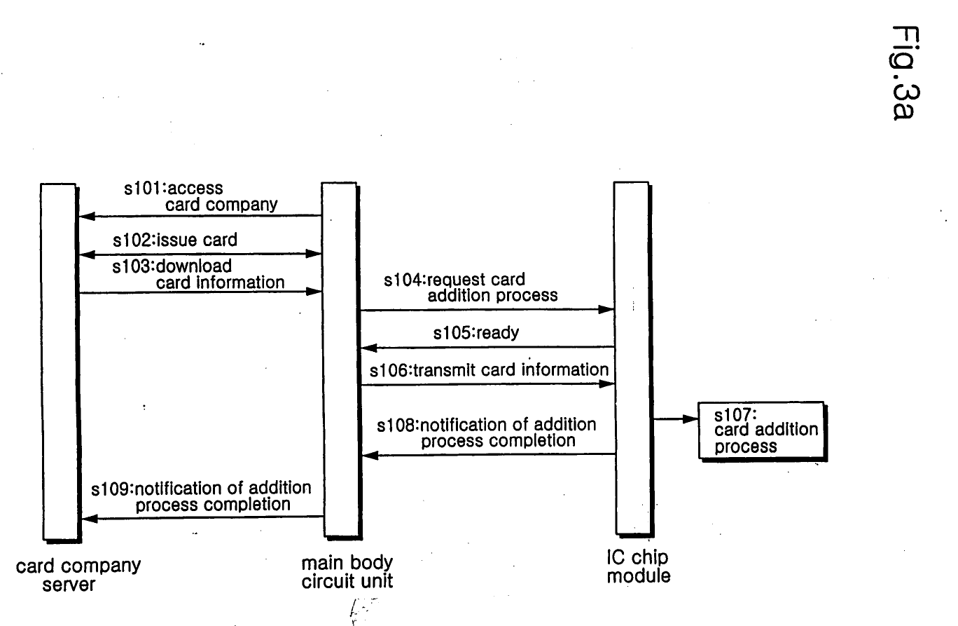

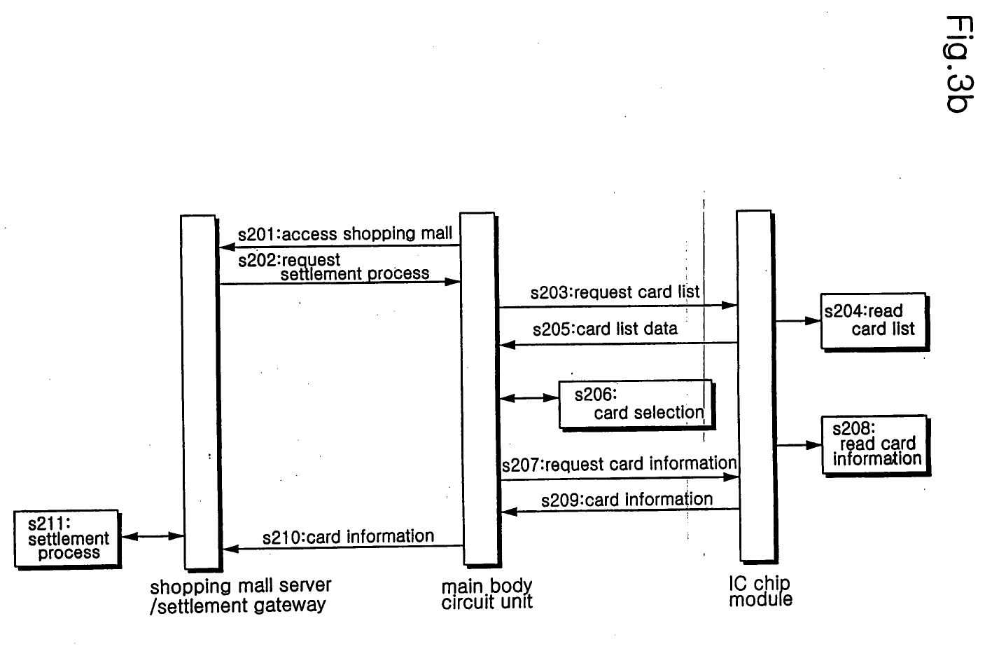

The control operation of the controller 100 will be described below in detail with reference to the flow diagrams of FIGS. 3a and 3b.

The IC chip module 20 includes a chip controller 200, a memory 400 and the chip interface 600, and may further include an RF communication module 800 according to an additional aspect of the present invention. These elements, except the RF communication module 800, are currently provided commercially in the form of a package into which they are integrated. The memory 400 is implemented as an electrically erasable and writable memory such as an EEPROM or a flash memory. The IC chip module 20 may need a power supply circuit to perform reading/writing of this memory.

The memory 400 includes a COS (Card Operating System) region 410, a card data region 430, a security module region 450 and a temporary data region 470. A card operating system is stored in the COS region 410, card information including a card number and a validity period is stored in the card data region 430, a card security module including a security key and a security processor module are stored in the security module region 450, and temporary data produced during processing is stored in the temporary data region 470. In the following description, the card operating system, the card information, the security module and the temporary data, respectively stored in the regions 410, 430, 450 and 470 are denoted, as needed, by the same reference numerals as the regions 410, 430, 450 and 470 for simpler description. In the embodiment of the present invention, the memory 400 may further include a card access portion 490. Currently used card settlement terminals access only a specific region of the memory to read card information. For this reason, the memory 400 further includes the card access portion 490 as the specific region.

Such individual hardware configuration in the present invention is already known in the art, and a detailed description thereof is thus omitted in this description. In the following, a detailed description will be given of the control operation of each of the controller 100 in the main body circuit unit 10 and the chip controller 200 in the IC chip module 20. The controller 100 in the main body circuit unit 10 includes a portion implemented by a program code. The most recent mobile communication terminals provide an excellent environment for executing an application program based on a virtual machine. Those skilled in the art can thus implement such a program from the following detailed description. It is preferable that, after being programmed, the card operating system for controlling the IC chip module 20 is provided by being stored in the memory 400, an electrically programmable non-volatile memory, in the IC chip module 20.

The controller 100 includes a main controller 110 for performing general voice or data communication and controlling the overall operation of the entire system. The controller 100 further includes a card update unit 150 for receiving card information updated through the communication module 300 and requesting, via the external interface 550, that the IC chip module 20 update the card information.

When it receives an issued card through a communication network, the card update unit 150 transfers it to the IC chip module 20 through the external interface 550 after the authentication process thereof so that the issued card is stored in the card data region 430 of the memory 400 in the IC chip module 20 under the control of the card operating system 410. Also when another new card is issued, the card update unit 150 performs the same process as describe above, so that a plurality of cards are stored in the IC chip module 20. Since the security module 450 may differ for each card, it must also be received and transferred together with the card by the card update unit 150.

On the other hand, according to an advantageous aspect of the present invention, the card update unit 150 can modify data of a card that has already been issued. For example, in the case where the issued card is a membership card, in order to additionally store authorized data related to information of various benefits or membership class adjustment, the card update unit 150 receives the data and then transmits it to the IC chip module 20 through the external interface 550, so that the content of the card data region 430 in the memory 400 in the IC chip module 20 is modified according to the received data under the control of the card operating system 410.

The controller 100 further includes a transaction processor 130 that operates in the following manner. In response to manipulation of the keypad 510 in performing a transaction process through the communication module 300, the transaction processor 130 requests, via the external interface, to perform the transaction process, and then receives the response data to perform the transaction process through the communication module 300.

For example, when a user accesses a settlement terminal supporting IR communication and manipulates a button for requesting settlement, the control is handed over from the main controller 110 to the transaction processor 130, which requests encoded card data from the card operating system 410 through the external interface 550. Upon receipt of this request from the chip interface 600, the card operating system 410 encodes selected or prescribed card information in the card data 430 through the security module 450, and transmits the encoded card information through the chip interface 600. The transaction processor 130 transmits the encoded card data to the second communication unit 330 as an IR communication unit. The external settlement terminal receives the transmitted data, and performs the same transaction process as if it were reading a general contact-free card. The present invention is not limited to the IR interface, and can also be applied to one of the Bluetooth interface described above and other known wireless communication interfaces.

In another example, when a user is requested to perform card settlement while using the wireless Internet, if the user pushes a card settlement button, the corresponding application program is executed so that the control is handed over to the transaction processor 130. The transaction processor 130 receives encoded card information from the IC chip module 20. After decoding it or without modifying it, the transaction processor 130 re-encodes the received card information through a security module that the corresponding settlement gateway requires, and then transmits it. This allows the user to avoid the inconvenience of inputting a card number and a validity period in order to perform the card settlement when using the wireless Internet, and further to benefit from a high security level.

Next, a description will be given of the chip controller 200 in the IC chip module 20 that is controlled by the execution of the card operating system 410. The chip controller 200 includes a contact-free transaction processor 224, a communication transaction processor 224 and a card update unit 240. The contact-free transaction processor 224 receives contact-free transaction request information from the outside through an RF communication module 800, and reads card information from the memory 400 and outputs the read card information through the RF communication module 800, so as to perform the settlement process. When it receives the transaction request information through the chip interface 600, the communication transaction processor 224 accesses the card information 430 of the memory 400, and outputs it through the chip interface 600. The card update unit 240 receives the card information through the chip interface 600, and updates the card data in the memory 400.

Currently used settlement terminals for IC chip cards access only a specific region in the IC chip card memory to read the card data. The memory 400 thus includes a card access portion 490 corresponding to the specific memory region. The present embodiment will be described based on such currently used cards, but the present invention is not limited thereto since more flexible communication may be performed by supplementing the card operating system 410.

The contact-free transaction processor 224 starts its process in a state where the card information of a card, which is appointed though communication between the main body of the mobile communication terminal and the card operating system 410 via the chip interface 600 according to the selection of a user in the main body, is stored in the card access portion 490. When it receives a transaction request through the RF communication module 800, the card operating system 410 detects the transaction request and reads data in the card access portion 490, and outputs the read data through the RF communication module 800. At this time, the card information can be outputted after being encoded by the security module 450.

When it receives a request to perform a transaction process from the chip interface 600, the communication transaction processor 224 reads the appointed card data from the card access portion 490, and preferably executes the security module 450 to encode the read data and outputs it to the chip interface 600.

Card information of a plurality of cards can be stored in the card data region 430 of the memory 400. Accordingly, a plurality of security modules, respectively, for a plurality of kinds of cards can also be stored in the security module region 450. The card update unit 240 performs an update process on card information and a security module of each of the cards through the chip interface 600. The card information update process includes the reflection of alteration of an existing card information, the disposal of a card as the existing card information thereof is deleted, and the addition of card information as a new card is issued.

FIG. 3a is a flow diagram showing the procedure of issuing a card, according to the preferred embodiment of the present invention. First, a mobile communication terminal accesses a server of a card company through a wireless data network (s101). Thereafter, a process for issuing a card is performed on a wireless Internet site (s102). When the card issuance process has been terminated, the card information thereof is downloaded online (s103). This process corresponds to online card delivery.

The present invention is not limited to this process, but may include an alternative process as follows. That is, after an offline card issuance process has been terminated, the card information thereof is directly transmitted to a terminal in the form of an SMS message, etc., and a specific tag in the message activates a card addition program, and then its subsequent processes are performed according to the user's approval or request.

Thereafter, the card update unit 150 among the program modules of the controller 100 in the main body circuit unit 10 requests, via the external interface 550, that the IC chip module 20 perform a card addition process (s104). This allows the card update unit 240 of the chip controller 200 in the IC chip module 20 to be invoked and activated, and thus the main body circuit unit 10 is informed that it is ready to perform the addition process (s105). At this time, if the transaction process is currently performed or a different process is underway, the main body circuit unit 10 enters a standby state. If it is a ready state, the card information is transmitted from the main body circuit unit 10 to the IC chip module 20 (s106). Accordingly, the card update unit 240 in the IC chip module 2θ adds the card information to the card data 430. If needed, the card update unit 240 also simultaneously or subsequently downloads the security module and adds it to the security module region 450, so as to add the downloaded security module to the management list (s107).

If the addition process has been completed, the IC chip module 20 informs the main body circuit unit 10 of the addition process completion (s108), and the main body circuit unit 10 informs the card company server of the completion (s109), so as to terminate the procedure.

The card information update procedure is very similar to the above procedure, except that the existing information is updated, and a detailed description thereof is thus omitted.

FIG. 3b shows the procedure for performing online settlement according to the embodiment of the present invention.

A user gains access to paid content (for example, in a shopping mall) by using a mobile communication terminal (s201). If the user is requested to perform payment while accessing the paid content (s202), the user starts a corresponding payment process by pushing a specific button. This allows the main body circuit unit 10 to request stored card information from the IC chip module 20 (s203). This step s203 is not essential, and alternatively, the main body circuit unit 10 can display a previously stored card list without performing communication with the IC chip module 20. In this case, it is advantageous in terms of security to store the card list in a form specified or recognizable by the user and identify it in the IC chip module 20, rather than to store the card list in card number form.

If it receives a request for the card list, the IC chip module 20 reads the card list from a specific region of the memory 400 (s204), and transmits the read card list to the main body circuit unit 10 (s205). The main body circuit is unit 10 displays the transmitted card list on the display unit 530. If the user selects a card by moving a cursor on the card list or by inputting a corresponding number (s206), the main body circuit unit 10 requests card information of the selected card from the IC chip module 20 (s207). Accordingly, the IC chip module 10 reads the requested card information from the card data region 430 in the memory 400, and transmits the read card information to the main body circuit unit 10 after encoding it by the security module 450 (s209). The main body circuit unit 20 transmits this card information to a shopping mall server or a settlement gateway through the communication module 300, particularly, through the first communication unit 310 (s210). Upon receipt of the card information, the shopping mall server or the settlement gateway queries a card company server about the received card information, so as to check settlement approval and perform a corresponding settlement process as in a general settlement procedure (s211).

In the case where a contact-free card settlement is performed, the IC chip module 20 performs the settlement process independently without the control of the main body circuit unit 10, and a description thereof is omitted since it has the same operation as a general card operating system. However, a process of selecting a card to be subjected to the settlement process as a contact-free card is performed in a similar manner to the card selection process of FIG. 3b. In addition, there is a difference in that the selected card information is copied to and stored in the card access portion 490 in the memory 400.

### Industrial Applicability

As apparent from the above description, the present invention makes it possible to perform online settlement or card information update by directly accessing an IC chip module for settlement embedded in a mobile communication terminal. It is also possible to store a plurality of cards while benefiting from a high security level of the IC chip itself.

A card in the present invention should be construed to include pre-payment and post-payment cards. Although it has been described with reference to the embodiments for illustrative purposes, the present invention is not limited to the embodiments, and those skilled in the art will appreciate that various modifications, additions and substitutions are possible, without departing from the spirit of the invention as disclosed in the accompanying claims. The claims are intended to include all possible modifications that those skilled in the art can make obviously from the above embodiments without departing from the scope of the invention.

1. A mobile communication terminal comprising an IC chip module and a main body circuit unit, said IC chip module being embedded in the mobile communication terminal,
said IC chip module including:
a memory for storing a card operating system and card information;
a chip interface for performing data transmission/reception with the outside; and
a chip controller being controlled by the card operating system to update card information and perform a transaction process through the chip interface,
said main body circuit unit including:
a key pad;
a display unit;
a communication module; and
a controller for receiving card information through the communication module, and requesting, via an external interface, to update the card information in the IC chip module.

2. The mobile communication terminal according to claim 1, wherein said chip controller includes:
a card update unit for receiving card information through the chip interface and then updating card data in the memory; and
a transaction processor for processing transaction data,
wherein said controller in the main body circuit unit includes a card update unit for receiving updated card information through the communication module and then requesting, via the external interface, that the IC chip module perform card information update.

3. The mobile communication terminal according to claim 2, wherein the controller in the main body circuit unit further includes a transaction processor for requesting, via the external interface, to perform a transaction process in response to manipulation of the key pad, when the transaction process is performed through the communication module, and receiving response data to perform the transaction process through the communication module,
wherein the transaction processor in the IC chip module includes a communication transaction processor for accessing the card information in the memory upon receipt of transaction request information through the chip interface and outputting it through the chip interface.

4. The mobile communication terminal according to claim 2, wherein the IC chip module further includes an RF communication module for communicating wirelessly with an external transaction terminal,
wherein the transaction processor in the chip controller includes a contact-free transaction processor for receiving contact-free transaction request information from the outside through the RF communication module, reading card information in the memory, and outputting the read card information through the RF communication module, so as to perform a settlement process thereof.

5. The mobile communication terminal according to claim 3 or 4, wherein in the IC chip module, the memory stores a plurality of cards' information; the card update unit individually accesses the plurality of cards' information in the memory and updates each card's information; and the transaction processor performs the transaction process by selecting card information of a card selected through the chip interface from a plurality of cards.

6. The mobile communication terminal according to claim 5, wherein the memory in the IC chip module includes a card access portion, and the transaction processor in the chip controller stores card information of a card, selected from a plurality of cards, in the card access portion.

7. The mobile communication terminal according to claim 5, wherein the communication module in the main body circuit unit includes:
a first communication unit for supporting voice and data communication with a base station; and
a second communication unit for supporting local wireless communication with an access point,
wherein the transaction processor selectively accesses the first or second communication units.

8. The mobile communication terminal according to claim 7, wherein the second communication unit is a Bluetooth communication module.

9. The mobile communication terminal according to any one of claims 1 to 3, wherein the IC chip module is embedded in a battery pack of the mobile communication terminal.

10. A mobile communication terminal comprising an IC chip module and a main body circuit unit, said IC chip module being embedded in the mobile communication terminal,
said IC chip module including:
a memory for storing a card operating system and card information;
a chip interface for performing data transmission/reception with the outside; and
a chip controller being controlled by the card operating system, said controller including a communication transaction processor for accessing the card information in the memory upon receipt of transaction request information through the chip interface and outputting it through the chip interface,
said main body circuit unit including:
a key pad;
a display unit;
a communication module; and
a controller including a transaction processor for requesting, via the external interface, to perform a transaction process in response to manipulation of the key pad when a transaction process is performed through the communication module, and receiving response data to perform the transaction process through the communication module.

11. The mobile communication terminal according to claim 10, wherein the IC chip module further includes an RF communication module for communicating wirelessly with an external transaction terminal,
wherein the transaction processor in the chip controller includes a contact-free transaction processor for receiving contact-free transaction request information from the outside through the RF communication module, reading card information in the memory, and outputting the read card information through the RF communication module, so as to perform a settlement process thereof.

12. The mobile communication terminal according to claim 10, wherein in the IC chip module, the memory stores a plurality of cards' information; the card update unit individually accesses the plurality of cards' information in the memory and updates each card's information; and the transaction processor performs the transaction process by selecting card information of a card selected through the chip interface from a plurality of cards.

13. A battery pack device detachably coupled to a mobile communication terminal, comprising:
a memory for storing a card operating system and card information;
a chip interface for performing data transmission/reception with a main body of the mobile communication terminal;
an RF communication module for communicating wirelessly with an external transaction terminal; and
a chip controller being controlled by the card operating system, said chip controller including a contact-free transaction processor and a card update unit, said contact-free transaction processor receiving contact-free transaction request information from the outside through the RF communication module, reading card information in the memory, and outputting the read card information through the RF communication module, so as to perform a settlement process thereof, said card update unit receiving card information through the chip interface and updating the card data in the memory.

14. The battery pack device according to claim 13, wherein the chip controller further includes a communication transaction processor for accessing the card information in the memory upon receipt of transaction request information through the chip interface and outputting it through the chip interface.

15. The battery pack device according to claim 13 or 14, wherein in the IC chip module, the memory stores a plurality of cards' information; the card update unit individually accesses the plurality of cards' information in the memory and updates each card's information; and the transaction processor performs the transaction process by selecting card information of a card selected through the chip interface from a plurality of cards.

16. The battery pack device according to claim 15, wherein the, memory in the IC chip module includes a card access portion, and the transaction processor in the chip controller stores card information of a card, selected from a plurality of cards, in the card access portion.
